(19) United States
(12) Patent Application Publication
(10) Pub. No.: US 2026/0204600 A1
(43) Pub. Date: Jul. 16, 2026

(54) VALVULAR CONDUIT FOR FUEL CELL EJECTORS

(71) Applicant: GM Global Technology Operations LLC, Detroit, MI (US)

(72) Inventors: Devesh Pande, Lake Orion, MI (US); Ronald Miller, Rochester, MI (US); Timothy James Howitt, Oxford, MI (US); Joseph Hahn, White Lake Charter Township, MI (US)

(21) Appl. No.: 19/021,471

(22) Filed: Jan. 15, 2025

(51) Int. Cl. H01M 8/04089; B60L 50/75; H01M 8/04082; H01M 8/04119; H01M 8/0438; H01M 8/1004

(52) U.S. Cl. CPC H01M 8/04097; B60L 50/75; H01M 8/04179; H01M 8/04201; H01M 8/04388; H01M 8/1004

(57) ABSTRACT

Aspects of the disclosure include fuel cell ejectors having valvular conduits (e.g., Tesla valves) for hydrogen recirculation systems. An exemplary vehicle includes an electric motor, a battery, a proton exchange membrane fuel cell (PEMFC), and a hydrogen recirculation system. The hydrogen recirculation system includes a hydrogen storage tank and a fuel cell ejector. The fuel cell ejector includes a primary flow nozzle coupled to the hydrogen storage tank, a secondary inlet coupled to the PEMFC, a suction chamber coupled to the primary flow nozzle and the secondary inlet, and a valvular conduit manifold positioned between the secondary inlet and an outlet of the PEMFC, the valvular conduit manifold including at least one minor return loop and at least one major return loop shaped such that hydrogen flows preferentially across the secondary inlet in a first direction from the PEMFC to the suction chamber.

### INTRODUCTION

The present disclosure relates to hydrogen fuel cells and electrolysis, and particularly to a valvular conduit (e.g., a Tesla valve) for fuel cell ejectors in a hydrogen fuel cell system.

Hydrogen fuel cells and related technologies have emerged as a promising clean energy solution, offering high efficiency and zero regulated emissions for various applications ranging from transportation (e.g., personal and commercial vehicles, shipping, aircraft, etc.) to stationary power generation. In a hydrogen fuel cell, hydrogen enters through an anode, where it's split into protons and electrons. The protons pass through an electrolyte membrane, while electrons flow through an external circuit, generating electricity. At the cathode, protons, electrons, and oxygen combine to produce water. Hydrogen fuel cells are typically implemented in fuel cell stacks-assemblies of multiple individual hydrogen fuel cells connected in series to increase overall voltage and power output.

### SUMMARY

In one exemplary embodiment a vehicle includes an electric motor, a battery, a proton exchange membrane fuel cell (PEMFC), and a hydrogen recirculation system. The hydrogen recirculation system includes a hydrogen storage tank and a fuel cell ejector coupled to the hydrogen storage tank and the PEMFC. The fuel cell ejector includes a primary flow nozzle coupled to the hydrogen storage tank, a secondary inlet coupled to the PEMFC, a suction chamber coupled to the primary flow nozzle and the secondary inlet, and a valvular conduit manifold positioned between the secondary inlet and an outlet of the PEMFC, the valvular conduit manifold including at least one minor return loop and at least one major return loop shaped such that hydrogen flows preferentially across the secondary inlet in a first direction from the PEMFC to the suction chamber.

In some embodiments, the minor return loops and the major return loops are diverting loops that create turbulence and eddies that impede a reverse flow of hydrogen in a second direction from the suction chamber to the PEMFC.

In some embodiments, the fuel cell ejector includes a diffusion chamber and a mixing chamber between the diffusion chamber and the suction chamber. In some embodiments, the suction chamber is positioned between the primary flow nozzle and the mixing chamber.

In some embodiments, the valvular conduit manifold includes one or more stackable plates. In some embodiments, each of the one or more stackable plates includes a plurality of valvular conduits.

In some embodiments, the plurality of valvular conduits are arranged into one or more paths through each respective stackable plate.

In some embodiments, each of the plurality of valvular conduits includes a minor return loop and a major return loop.

In some embodiments, each of the one or more stackable plates includes a same number of paths, a same number of minor return loops, and a same number of major return loops.

In another exemplary embodiment a fuel cell ejector includes a primary flow nozzle coupled to a hydrogen storage tank, a secondary inlet coupled to a PEMFC, a suction chamber coupled to the primary flow nozzle and the secondary inlet, and a valvular conduit manifold positioned between the secondary inlet and an outlet of the PEMFC. The valvular conduit manifold includes at least one minor return loop and at least one major return loop shaped such that hydrogen flows preferentially across the secondary inlet in a first direction from the PEMFC to the suction chamber.

In some embodiments, the minor return loops and the major return loops are diverting loops that create turbulence and eddies that impede a reverse flow of hydrogen in a second direction from the suction chamber to the PEMFC.

In some embodiments, the fuel cell ejector includes a diffusion chamber and a mixing chamber between the diffusion chamber and the suction chamber. In some embodiments, the suction chamber is positioned between the primary flow nozzle and the mixing chamber.

In some embodiments, the valvular conduit manifold includes one or more stackable plates. In some embodiments, each of the one or more stackable plates includes a plurality of valvular conduits.

In some embodiments, the plurality of valvular conduits are arranged into one or more paths through each respective stackable plate.

In some embodiments, each of the plurality of valvular conduits includes a minor return loop and a major return loop.

In some embodiments, each of the one or more stackable plates includes a same number of paths, a same number of minor return loops, and a same number of major return loops.

In yet another exemplary embodiment a method can include providing a fuel cell ejector for a hydrogen recirculation system. In some embodiments, the fuel cell ejector includes a valvular conduit manifold. The method can include coupling a primary flow nozzle of the fuel cell ejector to a hydrogen storage tank, coupling a secondary inlet of the fuel cell ejector to an outlet of a PEMFC, coupling a suction chamber to the primary flow nozzle and the secondary inlet, and positioning the valvular conduit manifold between the secondary inlet and the outlet of the PEMFC. In some embodiments, the valvular conduit manifold includes at least one minor return loop and at least one major return loop shaped such that hydrogen flows preferentially across the secondary inlet in a first direction from the PEMFC to the suction chamber.

In some embodiments, the minor return loops and the major return loops are diverting loops that create turbulence and eddies that impede a reverse flow of hydrogen in a second direction from the suction chamber to the PEMFC.

In some embodiments, the fuel cell ejector includes a diffusion chamber and a mixing chamber between the diffusion chamber and the suction chamber. In some embodiments, the suction chamber is positioned between the primary flow nozzle and the mixing chamber.

In some embodiments, the valvular conduit manifold includes one or more stackable plates. In some embodiments, each of the one or more stackable plates includes a plurality of valvular conduits.

In some embodiments, the plurality of valvular conduits are arranged into one or more paths through each respective stackable plate.

In some embodiments, each of the plurality of valvular conduits includes a minor return loop and a major return loop.

In some embodiments, each of the one or more stackable plates includes a same number of paths, a same number of minor return loops, and a same number of major return loops.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 depicts a vehicle configured in accordance with one or more embodiments;

FIG. 2A depicts a view of a hydrogen recirculation system in accordance with one or more embodiments;

FIG. 2B depicts a view of a fuel cell ejector of the hydrogen recirculation system of FIG. 2A in accordance with one or more embodiments;

FIG. 3 depicts a valvular conduit manifold in accordance with one or more embodiments;

FIG. 4 depicts a stackable plate of the valvular conduit manifold of FIG. 3 in accordance with one or more embodiments;

FIG. 5A depicts a top-down view of the stackable plate of FIG. 4 in accordance with one or more embodiments;

FIG. 5B depicts a cross-sectional view of the stackable plate of FIG. 4 along the line A-A in accordance with one or more embodiments;

FIG. 6A depicts a top-down view of the stackable plate of FIG. 4 in accordance with one or more embodiments;

FIG. 6B depicts a top-down view of the stackable plate of FIG. 4 in accordance with one or more embodiments;

FIG. 7A depicts a multi-piece composite fuel cell with an integrated anode subsystem in accordance with one or more embodiments;

FIG. 7B depicts a first piece of the multi-piece composite fuel cell of FIG. 7A in accordance with one or more embodiments;

FIG. 7C depicts a second piece of the multi-piece composite fuel cell of FIG. 7A in accordance with one or more embodiments;

FIG. 8A depicts a stackable plate of the valvular conduit manifold of FIG. 3 in accordance with one or more embodiments;

FIG. 8B depicts a cross-sectional view of the stackable plate of FIG. 8A along the line B-B in accordance with one or more embodiments;

FIG. 8C depicts a stackable plate of the valvular conduit manifold of FIG. 3 in accordance with one or more embodiments; and

FIG. 9 is a flowchart in accordance with one or more embodiments.

### DETAILED DESCRIPTION

The following description is merely exemplary in nature and is not intended to limit the present disclosure, its application or uses.

Understanding and optimizing hydrogen fuel cells and their various support systems, such as electrolysis cells (also referred to as electrolyzers), has become crucial for widespread adoption and commercialization of hydrogen fuel cell technologies. In particular, the Proton Exchange Membrane Fuel Cell (PEMFC) has emerged as a promising clean energy technology that converts chemical energy from hydrogen into electrical energy through an electrochemical reaction. These fuel cells operate at relatively low temperatures (e.g., 50-100° C.) and offer relatively high power densities, making them suitable for various applications, including transportation and portable power systems. PEMFCs consist of an anode, a cathode, and a proton-conducting polymer membrane electrolyte that allows only protons to pass through while blocking electrons. For PEMFCs to function efficiently, hydrogen is continuously delivered to the active area of the fuel cell where the electrochemical reaction that generates electricity occurs (e.g., at the interface between the catalyst layer and the membrane). Proper hydrogen delivery ensures a continuous supply of fuel to sustain the reaction and maintain optimal performance. Complicating matters, not all hydrogen introduced into the fuel cell is consumed in a single pass, necessitating a system for recirculating unused hydrogen. Thus, components such as ejectors and recirculation pumps have been integrated into the fuel cell design to manage and optimize hydrogen flow, improving fuel utilization, and maintaining appropriate pressure levels within the fuel cell system.

An ejector is, in essence, a device that increases the pressure of a fluid such as hydrogen gas to overcome the frictional losses associated with mass transport. Within a PEMFC specifically, a fuel cell ejector is used to maintain the flow of hydrogen on the anode side of the fuel cell. Typically, this function is fulfilled by pumps, such as recirculation pumps. A major disadvantage of such pump-based recirculation systems is the large amounts of power required, usually on the order of several kilowatts, to achieve the required pressure lift. This power, produced by the fuel cell system, is directly consumed by the systems supporting its operation, and is therefore referred to as a parasitic loss.

The ejector aims to reduce the parasitic losses of the balance of plant in a PEMFC by tapping into another energy source: the potential energy stored as pressure within the hydrogen storage tanks. For example, in vehicle-based PEMFC implementations, hydrogen may be stored at approximately 700 bar, which must be brought back to near atmospheric pressure before it can be used in the fuel cell. Ordinarily, this throttling process is not used to produce useful work; however, ejector systems are designed to use this potential energy to increase the pressure of the hydrogen in the anode recirculation loop. This allows the anode side of the fuel cell to be supplied with an excess amount of hydrogen, ensuring proper operation.

In a fuel cell ejector system, one-way valves with flexible materials or composite reeds are often used to regulate gas flow through the ejector. These valves control the direction, rate, and pressure of the hydrogen gas as the gas moves through the ejector system and prevents backflow away from the anode. Reed valves, for example, are somewhat simple, lightweight devices that can provide a relatively fast gas regulation response (e.g., on the order of one hundred milliseconds). Unfortunately, reed valves and other mechanical and electrical gas regulation devices introduce moving parts and additional parasitic power requirements to the recirculation system, raising manufacturing, operational, and servicing complexities as well as reducing overall system efficiency. In particular, reed valves are susceptible to material fatigue as these types of valves constantly flex during operation. As a result, reed valves can require periodic replacement, especially in high-cycle applications.

This disclosure introduces a valvular conduit for fuel cell ejectors in a hydrogen fuel cell system. Rather than relying upon a reed valve or other mechanical or electrical one-way valve systems to regulate hydrogen flow, fuel cell ejectors described herein leverage valvular conduits designed to deliver hydrogen to the anode side of the fuel cell without requiring flexible materials or moving parts. A valvular conduit is a type of fluidic device designed to control the direction of fluid flow without the use of moving parts and can include a series of interconnected channels or pathways that create a preferential flow direction for a working fluid. While not meant to be particularly limited, valvular conduits can include, for example, Tesla valves, diode pumps, passive check valves, pinch valves, and siphon valves. In some embodiments, the valvular conduits (e.g., Tesla valves) control gas flow through a series of interconnected, shaped channels that create a complex path for fluid. Notably, in the intended flow direction (towards the anode), fluid moves with minimal resistance, while in the reverse direction (backflow away from the anode), diverting loops in the valvular conduits create turbulence and eddies that restrict flow.

In some embodiments, a number of valvular conduits can be integrated into stackable plates, which allows for modular scalability. The modular capability of the plates allows for the underlying system to be easily scaled by simply adding more plates, increasing the size of the flow field as needed. This approach results in a more reliable and effective solution for managing hydrogen flow in fuel cell systems.

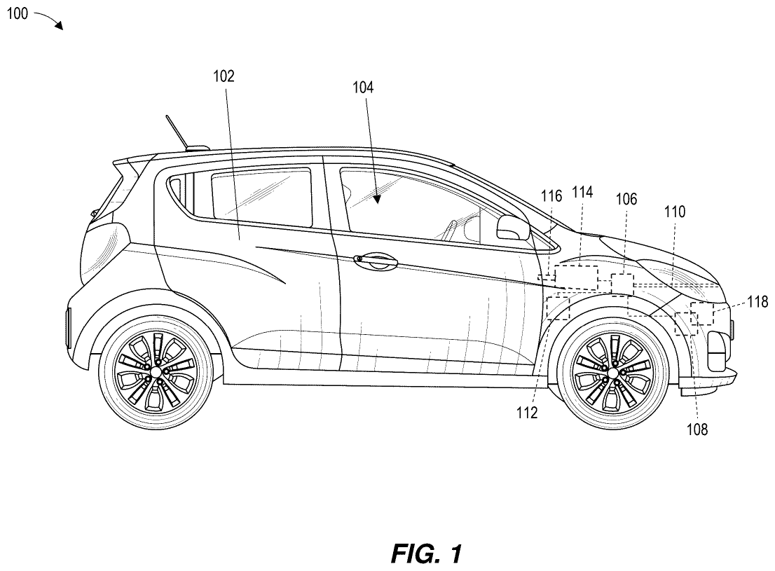

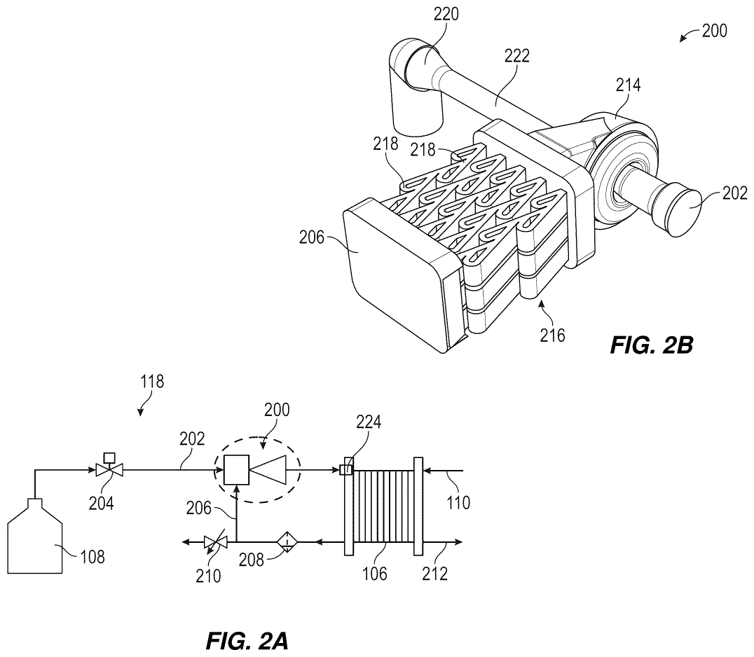

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, a proton exchange membrane fuel cell (PEMFC) 106 (also referred to as a “fuel cell stack”), a hydrogen fuel storage tank 108, an air intake manifold 110, a battery 112, and an electric motor 114 configured for utilizing electrical energy to provide an output torque to an output component 116 (each shown by projection near the front hood). PEMFC 106 receives a flow of hydrogen or other fuel gas from the hydrogen fuel storage tank 108 and receives a flow of air including oxygen gas from air intake manifold 110. The PEMFC 106 may include an air compressor device (not separately indicated) useful to pressurize the air to a desired pressure. The PEMFC 106 may provide electrical energy directly to the electric motor 114 and/or the PEMFC 106 may provide electrical energy to the battery 112 for storage and later use. The output component 116 may provide the output torque for usage, for example, to provide a motive force to the vehicle 100. In some embodiments, vehicle 100 includes a hydrogen recirculation system 118 configured to regulate and deliver hydrogen from the hydrogen fuel storage tank 108 to the PEMFC 106. As will be discussed in further detail below, the hydrogen recirculation system 118 includes a fuel cell ejector 200 having a valvular conduit manifold 216 (refer to FIG. 2) to direct hydrogen delivery to the PEMFC 106 and to prevent backflow towards the hydrogen fuel storage tank 108.

The PEMFC 106, hydrogen fuel storage tank 108, air intake manifold 110, battery 112, electric motor 114, and hydrogen recirculation system 118 are shown for ease of illustration and discussion only. It should be understood that the configuration, location, size, arrangement, etc., of these components is not meant to be particularly limited, and all such configurations (including multi-motor configurations) are within the contemplated scope of this disclosure. Moreover, while the present disclosure is discussed primarily in the context of a PEMFC 106 and hydrogen recirculation system 118 configured for the vehicle 100, aspects described herein can be similarly incorporated within any system (vehicle, building, or otherwise) having a hydrogen fuel cell-based power and/or energy storage system(s), and all such configurations and applications are within the contemplated scope of this disclosure. In particular, the hydrogen recirculation system 118 need not be incorporated within vehicle 100 at all, and, in some embodiments, is instead configured as an entirely separate unit for standalone hydrogen production systems (perhaps for serving vehicle 100 and/or other downstream applications).

FIG. 2A depicts a view of a hydrogen recirculation system 118 in accordance with one or more embodiments. As shown in FIG. 2A, hydrogen recirculation system 118 includes a PEMFC 106, a hydrogen fuel storage tank 108, and a fuel cell ejector 200, configured and arranged as shown.

In some embodiments, the hydrogen fuel storage tank 108 is coupled to a primary flow nozzle 202 of the fuel cell ejector 200. In some embodiments, a pressure reducing valve 204 is positioned between the hydrogen fuel storage tank 108 and the primary flow nozzle 202. The hydrogen fuel storage tank 108 can store hydrogen at relatively high pressures, such as pressures of several hundred bar (e.g., 700 bar), and the pressure reducing valve 204 can be positioned between the hydrogen storage tank 108 and the primary flow nozzle 202 to reduce this pressure to a lower pressure that is suitable for delivery to the PEMFC 106. Although not meant to be particularly limited, an example delivery pressure for hydrogen fuel after passing through the pressure reducing valve 204 can be less than 100 bar, such as, for example, 1 to 5 bar.

In some embodiments, the PEMFC 106 is coupled to a secondary inlet 206 (also referred to as the recirculation inlet) of the fuel cell ejector 200. In some embodiments, a gas-water separator 208 is positioned between the PEMFC 106 and the secondary inlet 206. During the operation of the PEMFC 106, water is produced as a byproduct of electrochemical reactions occurring within active areas of the PEMFC 106. The water can mix with unspent hydrogen gas, resulting in operational inefficiencies. Gas-water separator 208 separates this water from the hydrogen gas before the hydrogen gas is recirculated back through the fuel cell ejector 200. In this manner, the gas-water separator 208 ensures that dry hydrogen gas, free from excess water, is directed back into the fuel cell ejector 200, thereby maintaining desired performance and efficiency targets.

In some embodiments, a purge valve 210 is positioned downstream of the gas-water separator 208. In some embodiments, purge valve 210 periodically and/or continuously releases accumulated water and other impurities from the hydrogen recirculation system 118. More specifically, after the gas-water separator 208 removes excess water from the hydrogen gas leaving PEMFC 106, the purge valve 210 allows for a controlled expulsion of this separated water, alongside any other contaminants that may have been collected, from the hydrogen recirculation system 118. This process helps to maintain the purity and quality of the hydrogen gas being recirculated back into the fuel cell ejector 200.

As further shown in FIG. 2A, the PEMFC 106 can be coupled to an air intake manifold 110 and an air outlet manifold 212. The air intake manifold 110 is responsible for delivering a supply of air, which contains oxygen, to the cathode side of the PEMFC 106. Oxygen is a primary component of the electrochemical reactions that occur within the PEMFC 106, as oxygen combines with protons and electrons during those reactions to produce water and electricity. The air outlet manifold 212, on the other hand, serves to expel the exhaust gases, primarily consisting of water vapor and any unreacted oxygen, from the PEMFC 106. Together, these components ensure that the PEMFC receives a continuous and controlled flow of oxygen while efficiently removing the byproducts of the electrochemical reactions.

FIG. 2B depicts a view of the fuel cell ejector 200 of the hydrogen recirculation system 118 of FIG. 2A in accordance with one or more embodiments. As shown in FIG. 2B, the fuel cell ejector 200 includes a primary flow nozzle 202 and a secondary inlet 206 coupled to a suction chamber 214. The suction chamber 214 provides a low-pressure zone that draws hydrogen gas from both the primary flow nozzle 202, which is ultimately connected to the hydrogen storage tank 108, and the secondary inlet 206, which is ultimately connected to the PEMFC 106. In this manner, the suction chamber 214 helps to recirculate unspent hydrogen gas back into the PEMFC 106, ensuring efficient utilization of hydrogen fuel.

As further shown in FIG. 2B, the fuel cell ejector 200 includes a valvular conduit manifold 216 positioned between the secondary inlet 206 and the suction chamber 214. The valvular conduit manifold 216 is designed to control the flow of hydrogen gas within the hydrogen recirculation system 118 without the need for moving parts. In some embodiments, the valvular conduit manifold 216 includes a series of interconnected, shaped channels, referred to herein as valvular conduits 218, that create a directionally preferential path for fluids (e.g., hydrogen) through the fuel cell ejector 200. More specifically, the valvular conduit manifold 216 preferentially directs hydrogen in an intended flow direction, from the PEMFC 106 and towards the suction chamber 214. Conversely, the valvular conduits 218 of the valvular conduit manifold 216 create turbulence and eddies that impede hydrogen backflow in the reverse direction, towards the PEMFC 106.

In some embodiments, the fuel cell ejector 200 includes a diffusion chamber 220 and a mixing chamber 222 positioned between the diffusion chamber 220 and the suction chamber 214. The diffusion chamber 220 can be coupled to an inlet 224 of the PEMFC 106. The diffusion chamber 220 serves to evenly distribute hydrogen flow to the PEMFC 106, reducing any pressure variations and ensuring a uniform flow rate before the hydrogen enters PEMFC 106. The mixing chamber 222, located between the diffusion chamber 220 and the suction chamber 214, provides a zone in which the primary, relatively higher-pressure hydrogen flow from the primary flow nozzle 202 mixes with the secondary, relatively lower-pressure recirculation flow from the secondary inlet 206 to create a combined hydrogen stream. In other words, the mixing chamber 222 refers to the region in which momentum transfer occurs between the two flows, allowing the secondary, recirculating hydrogen flow to be entrained by the primary hydrogen flow from the hydrogen fuel storage tank 108.

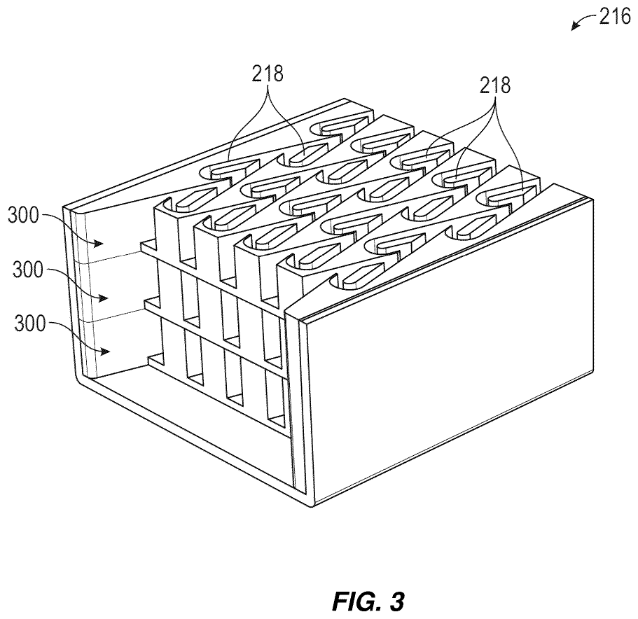

FIG. 3 depicts a valvular conduit manifold 216 (refer to FIG. 2B) in accordance with one or more embodiments. In some embodiments, the valvular conduit manifold 216 can include one or more stackable plates 300. For example, in the embodiment shown in FIG. 3, the valvular conduit manifold 216 includes three stackable plates 300. It should be understood that the valvular conduit manifold 216 depicted in FIG. 3 is for illustrative purposes only, and that the valvular conduit manifold 216 can include any number of stackable plates 300, such as, for example, 1 plate, 2 plates, 3 plates (as shown), 4 plates, 5 plates, 10 plates, 50 plates, 100 plates, etc. All such configurations are within the contemplated scope of this disclosure.

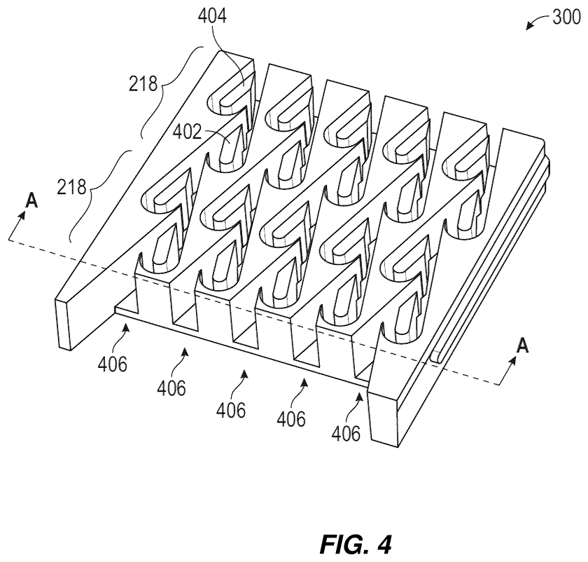

As further shown in FIG. 3, each of the stackable plates 300 can include one or more valvular conduits 218. In some embodiments, each of the stackable plates 300 can include a same number of valvular conduits 218. In some embodiments, each of the stackable plates 300 can include a same number and a same orientation of the one or more valvular conduits 218. In this manner, the stackable plates 300 can serve as modular components which can be manufactured in bulk and repeatedly stacked in any desired number to provide valvular conduit manifolds 216 having any desired hydrogen flow capacity. The individual stackable plates 300 are discussed in greater detail with respect to FIG. 4.

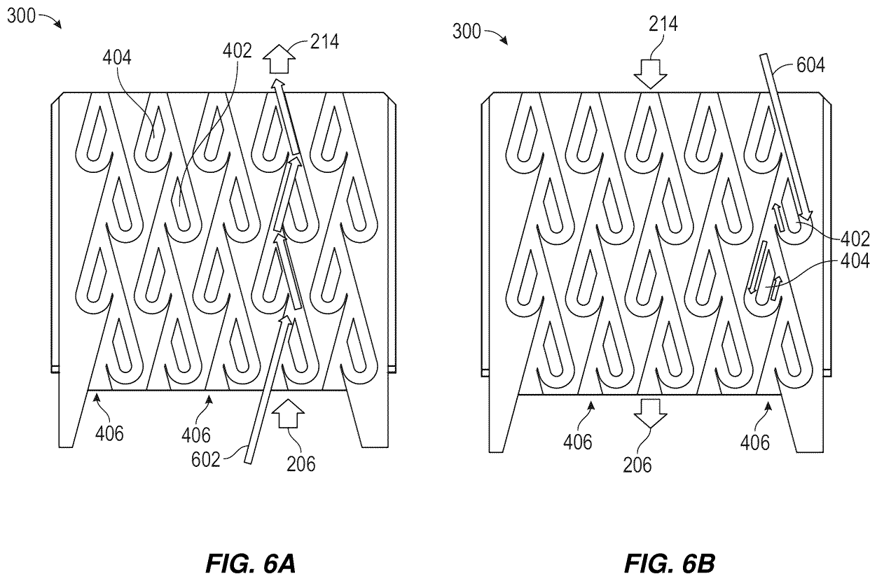

FIG. 4 depicts a stackable plate 300 of the valvular conduit manifold 214 of FIG. 3 in accordance with one or more embodiments. As shown in FIG. 4, a stackable plate 300 includes a plurality of valvular conduits 218. In some embodiments, each valvular conduit 218 includes a major loop 402 and a minor loop 404. In some embodiments, the plurality of valvular conduits 218 are arranged into one or more paths 406. For example, the stackable plate 300 shown in FIG. 4 includes five paths 406, although this configuration is merely illustrative. The stackable plate 300 can include any number of paths 406, such as, for example, 1 path, 2 paths, 3 paths, 4 paths, 5 paths (as shown), 10 paths, 20 paths, 100 paths, etc. Moreover, each path 406 can include any number of valvular conduits 218. For example, the stackable plate 300 shown in FIG. 4 includes paths 406, each having two valvular conduits 218, although this configuration is merely illustrative. The stackable plate 300 can include any number of valvular conduits 218, such as, for example, 1 valvular conduit, 2 valvular conduits (as shown), 3 valvular conduits, 4 valvular conduits, 5 valvular conduits, 10 paths, etc. All such configurations are within the contemplated scope of this disclosure. The paths 406 are discussed in greater detail with respect to FIGS. 6A and 6B.

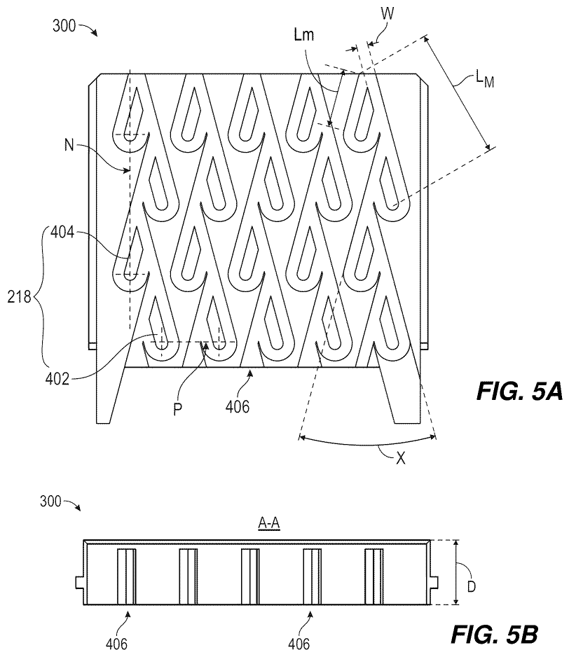

FIG. 5A depicts a top-down view of the stackable plate 300 of FIG. 4 in accordance with one or more embodiments. FIG. 5B depicts a cross-sectional view of the stackable plate 300 of FIG. 4 along the line A-A in accordance with one or more embodiments. As shown in FIGS. 5A and 5B, the stackable plate 300 includes a number of configurable parameters to tune the operation of the valvular conduit manifold 214 (refer to FIG. 3).

In some embodiments, the number N of valvular conduits per path 406 can be configured according to the needs of a given application. For example, the number N of valvular conduits per path 406 can be 2, or 5, or 10, etc. In some embodiments, the number P of paths 406 can be configured according to the needs of a given application. For example, the number P of paths 406 can be 1, 2, 3, 4, 5, 10, etc. In some embodiments, the length Lₘ of the minor loops 404 can be configured according to the needs of a given application. For example, the length Lₘ of the minor loops 404 can be 10 millimeters, 25 millimeters, 50 millimeters, 100 millimeters, etc. In some embodiments, the length L_{M} of the major loops 402 can be configured according to the needs of a given application. For example, the length L_{M} of the major loops 402 can be 10 millimeters, 25 millimeters, 50 millimeters, 100 millimeters, etc. In some embodiments, the length L_{M} of the major loops 402 is longer than the length Lₘ of the minor loops 404. In some embodiments, the width W of the paths 406 can be configured according to the needs of a given application. For example, the width W of the paths 406 can be 1 millimeter, 2 millimeters, 5 millimeters, 10 millimeters, 20 millimeters, 100 millimeters, etc. In some embodiments, the edge-to-edge angle X of the valvular conduits 218 can be configured according to the needs of a given application. For example, the edge-to-edge angle X of the valvular conduits 218 can be 5 degrees, 10 degrees, 20 degrees, 45 degrees, 60 degrees, etc. In some embodiments, the depth D of the paths 406 can be configured according to the needs of a given application. For example, the depth D of the paths 406 can be 1 millimeter, 2 millimeters, 5 millimeters, 10 millimeters, 20 millimeters, 100 millimeters, etc.

FIGS. 6A and 6B depict top-down views of the stackable plate 300 of FIG. 4 in accordance with one or more embodiments. More specifically, FIG. 6A depicts a preferential flow of hydrogen through the stackable plate 300, while FIG. 6B depicts a backflow of hydrogen through the stackable plate 300.

As shown in FIG. 6A, fluid (e.g., hydrogen fuel) can pass through the stackable plate 300 in a first direction 602 without looping through a major loop 402 or a minor loop 404. In some embodiments, the first direction 602 is a preferential direction through the stackable plate 300. In some embodiments, first direction 602 defines a path in which hydrogen fuel enters from the secondary inlet 206 from the PEMFC 106 and passes through the stackable plate 300 to the suction chamber 214 of the fuel cell ejector 200.

Conversely, as shown in FIG. 6B, fluid (e.g., hydrogen fuel) passing in a second direction 604 through the stackable plate 300 will loop through the major loop 402 and/or the minor loop 404. Without wishing to be bound by theory, diverting the flow of fluid through the major loops 402 and/or minor loops 404 creates turbulence and eddies that restrict flow. In other words, the relative magnitude of fluid flow in the second direction 604 will be less than the relative magnitude of fluid flow in the first direction 602. In some embodiments, the second direction 604 is an undesired backflow through the stackable plate 300. In some embodiments, second direction 604 defines a path in which hydrogen fuel backflows from the suction chamber 214 of the fuel cell ejector 200 and returns through the secondary inlet 206 towards the PEMFC 106.

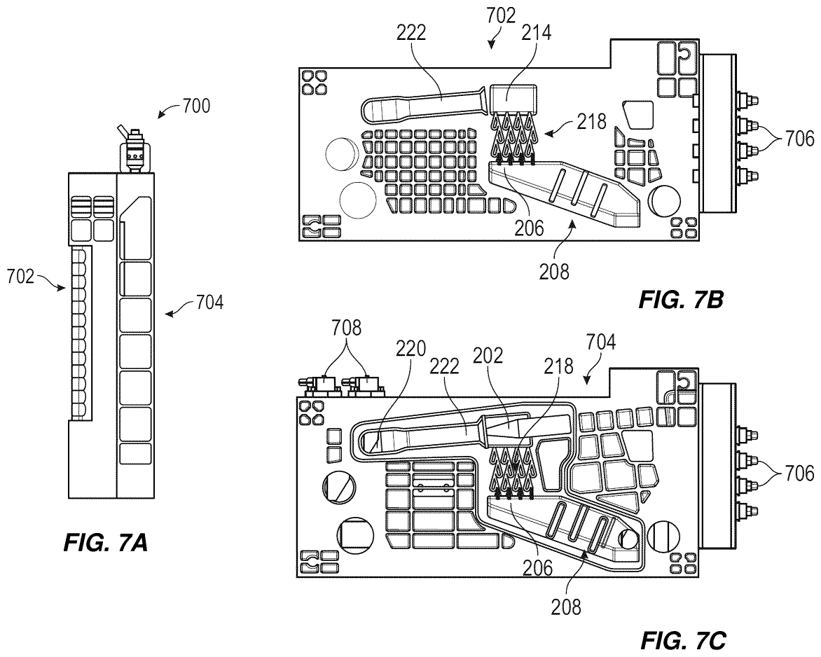

FIG. 7A depicts a multi-piece composite fuel cell 700 with an integrated anode subsystem in accordance with one or more embodiments. FIG. 7B depicts a first piece 702 of the multi-piece composite fuel cell 700 of FIG. 7A in accordance with one or more embodiments. FIG. 7C depicts a second piece 704 of the multi-piece composite fuel cell 700 of FIG. 7A in accordance with one or more embodiments.

As shown in FIG. 7A, the multi-piece composite fuel cell 700 includes a first piece 702 and a second piece 704 which can be fixed together to define the multi-piece composite fuel cell 700. These pieces can be joined using various methods to ensure a secure and reliable connection. In some embodiments, these pieces are joined via welding, where the edges of the first piece 702 and the second piece 704 are fused together using heat or pressure to create a strong bond. In other embodiments, adhesives can be used, where a high-strength adhesive material is applied to the joining surfaces to bond the pieces together. Additionally, mechanical fasteners such as bolts, screws, or clamps can be used to hold the pieces in place, providing a detachable option for assembly and disassembly. In some embodiments, a combination of these methods may be employed to achieve the desired level of structural integrity and durability for the multi-piece composite fuel cell 700. The choice of joining method depends on factors such as the materials used, the operating conditions, and the specific requirements of the fuel cell system.

As shown in FIGS. 7B and 7C, the multi-piece composite fuel cell 700 can include a gas-water separator 208, valvular conduits 218, a primary flow nozzle 202, a suction chamber 214, a mixing chamber 222, a diffusion chamber 220, and secondary inlet 206, each configured in a similar manner as previously described. In some embodiments, the multi-piece composite fuel cell 700 can also include fuel injectors 706 and pressure sensors 708. In some embodiments, the fuel injectors 706 are responsible for delivering controlled amounts of hydrogen fuel to the multi-piece composite fuel cell 700. The pressure sensors 708, on the other hand, can be positioned to monitoring the pressure levels at any point within the multi-piece composite fuel cell 700. In some embodiments, data collected by the pressure sensors 708 is used to ensure that hydrogen is delivered at a target pressure. In some embodiments, the pressure sensors 708 provide real-time feedback to a controller (not separately indicated) that can be used to adjust the operation of the fuel injectors 706 and other system components to increase or decrease the pressure as needed, ensuring that the multi-piece composite fuel cell 700 operates within a targeted pressure range.

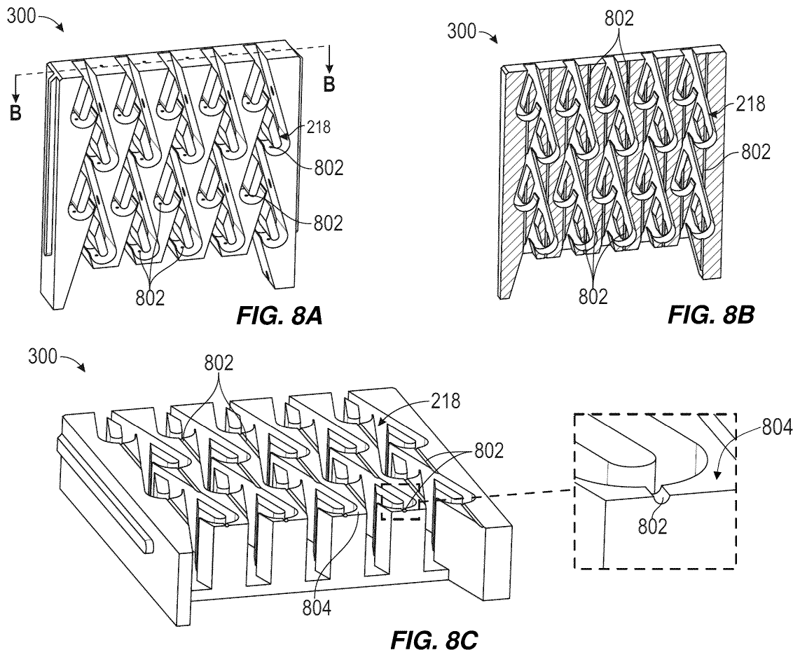

FIG. 8A depicts a stackable plate 300 of the valvular conduit manifold 214 of FIG. 3 in accordance with one or more embodiments. FIG. 8B depicts a cross-sectional view of the stackable plate 300 of FIG. 8A along the line B-B in accordance with one or more embodiments. As shown in FIGS. 8A and 8B, a stackable plate 300 includes a plurality of valvular conduits 218. In some embodiments, one or more of the valvular conduits 218 includes one or more drainage features 802.

In some embodiments, the drainage features 802 serve as a partial bypass of the plurality of valvular conduits 218. In this manner, excess or trapped fluids (e.g., retained fluids) can escape the stackable plate 300. In some embodiments, the drainage features 802 are formed to a diameter that is less than a depth D of the paths 406 (refer to FIG. 5B). In some embodiments, the drainage features 802 are formed to a diameter that is less than 10 percent, or 5 percent, or 3 percent, the depth D of the paths 406. For example, the drainage features 802 can be formed to a diameter of 0.1 mm, 0.3 mm, 0.5 mm, 0.75 mm, 1 mm, 2 mm, etc. In some embodiments, the drainage features 802 include one or more continuous passages through the stackable plate 300. As shown in FIG. 8B, the drainage features 802 can include a plurality of parallel continuous passages, although other configurations are possible and within the contemplated scope of this disclosure.

FIG. 8C depicts a stackable plate 300 of the valvular conduit manifold 214 of FIG. 3 in accordance with one or more embodiments. The stackable plate 300 shown in FIG. 8C includes one or more drainage features 802 in a similar manner as previously described for the stackable plate 300 shown in FIGS. 8A and 8B, except that the drainage features 802 in the embodiment shown in FIG. 8C are formed on a topmost surface 804 of the stackable plate 300 (rather than being embedded as shown in FIGS. 8A and 8B).

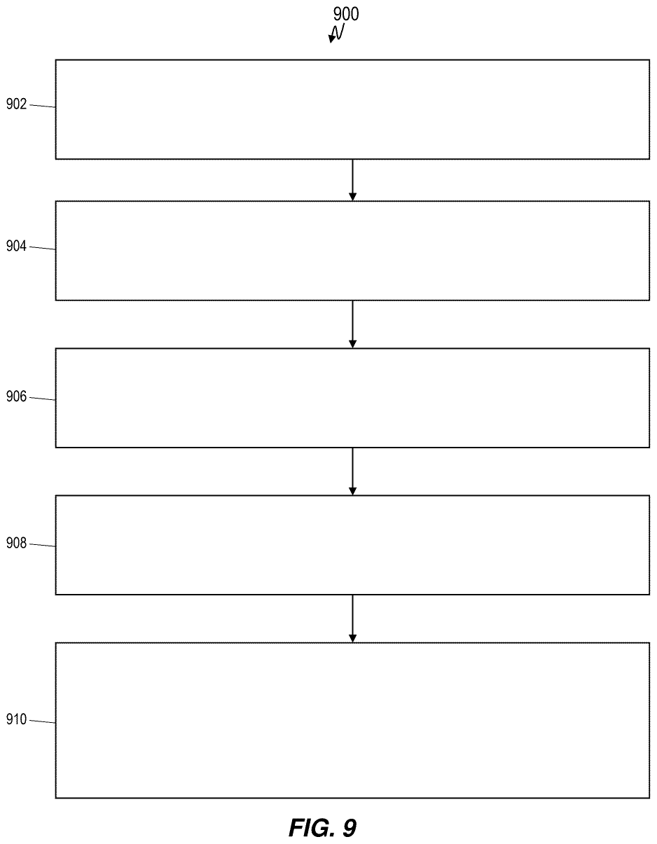

Referring now to FIG. 9, a flowchart 900 for leveraging a fuel cell ejector with valvular conduits for hydrogen recirculation is generally shown according to an embodiment. The flowchart 900 is described in reference to FIGS. 1-8C and may include additional steps not depicted in FIG. 9. Although depicted in a particular order, the blocks depicted in FIG. 9 can be rearranged, subdivided, and/or combined.

At block 902, the method includes providing a fuel cell ejector for a hydrogen recirculation system. In some embodiments, the fuel cell ejector includes a valvular conduit manifold.

At block 904, the method includes coupling a primary flow nozzle of the fuel cell ejector to a hydrogen storage tank.

At block 906, the method includes coupling a secondary inlet of the fuel cell ejector to an outlet of a PEMFC.

At block 908, the method includes coupling a suction chamber to the primary flow nozzle and the secondary inlet.

At block 910, the method includes positioning the valvular conduit manifold between the secondary inlet and the outlet of the PEMFC. In some embodiments, the valvular conduit manifold includes at least one minor return loop and at least one major return loop shaped such that hydrogen flows preferentially across the secondary inlet in a first direction from the PEMFC to the suction chamber.

In some embodiments, the minor return loops and the major return loops are diverting loops that create turbulence and eddies that impede a reverse flow of hydrogen in a second direction from the suction chamber to the PEMFC.

In some embodiments, the fuel cell ejector includes a diffusion chamber and a mixing chamber between the diffusion chamber and the suction chamber. In some embodiments, the suction chamber is positioned between the primary flow nozzle and the mixing chamber.

In some embodiments, the valvular conduit manifold includes one or more stackable plates. In some embodiments, each of the one or more stackable plates includes a plurality of valvular conduits.

In some embodiments, the plurality of valvular conduits are arranged into one or more paths through each respective stackable plate.

In some embodiments, each of the plurality of valvular conduits includes a minor return loop and a major return loop.

In some embodiments, each of the one or more stackable plates includes a same number of paths, a same number of minor return loops, and a same number of major return loops.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A} , {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor;
a battery electrically coupled to the electric motor;
a proton exchange membrane fuel cell (PEMFC) electrically coupled to at least one of the electric motor or the battery; and
a hydrogen recirculation system comprising:
a hydrogen storage tank; and
a fuel cell ejector coupled to the hydrogen storage tank and the PEMFC;
wherein the fuel cell ejector comprises:
a primary flow nozzle coupled to the hydrogen storage tank;
a secondary inlet coupled to an outlet of the PEMFC;
a suction chamber coupled to the primary flow nozzle and the secondary inlet; and
a valvular conduit manifold positioned between the secondary inlet and the outlet of the PEMFC, the valvular conduit manifold comprising at least one minor return loop and at least one major return loop shaped such that hydrogen flows preferentially across the secondary inlet in a first direction from the PEMFC to the suction chamber.

2. The vehicle of claim 1, wherein the at least one minor return loop and the at least one major return loop are diverting loops that create turbulence and eddies that impede a reverse flow of hydrogen in a second direction from the suction chamber to the PEMFC.

3. The vehicle of claim 1, wherein the fuel cell ejector further comprises:
a diffusion chamber; and
a mixing chamber between the diffusion chamber and the suction chamber;
wherein the suction chamber is positioned between the primary flow nozzle and the mixing chamber.

4. The vehicle of claim 1, wherein the valvular conduit manifold comprises one or more stackable plates, each of the one or more stackable plates comprising a plurality of valvular conduits.

5. The vehicle of claim 4, wherein the plurality of valvular conduits are arranged into one or more paths through each respective stackable plate.

6. The vehicle of claim 5, wherein each of the plurality of valvular conduits comprises a minor return loop and a major return loop.

7. The vehicle of claim 6, wherein each of the one or more stackable plates comprises a same number of paths, a same number of minor return loops, and a same number of major return loops.

8. A fuel cell ejector for a hydrogen recirculation system, the fuel cell ejector comprising:
a primary flow nozzle coupled to a hydrogen storage tank;
a secondary inlet coupled to an outlet of a proton exchange membrane fuel cell (PEMFC);
a suction chamber coupled to the primary flow nozzle and the secondary inlet; and
a valvular conduit manifold positioned between the secondary inlet and the outlet of the PEMFC, the valvular conduit manifold comprising at least one minor return loop and at least one major return loop shaped such that hydrogen flows preferentially across the secondary inlet in a first direction from the PEMFC to the suction chamber.

9. The fuel cell ejector of claim 8, wherein the at least one minor return loop and the at least one major return loop are diverting loops that create turbulence and eddies that impede a reverse flow of hydrogen in a second direction from the suction chamber to the PEMFC.

10. The fuel cell ejector of claim 8, wherein the fuel cell ejector further comprises:
a diffusion chamber; and
a mixing chamber between the diffusion chamber and the suction chamber;
wherein the suction chamber is positioned between the primary flow nozzle and the mixing chamber.

11. The fuel cell ejector of claim 8, wherein the valvular conduit manifold comprises one or more stackable plates, each of the one or more stackable plates comprising a plurality of valvular conduits.

12. The fuel cell ejector of claim 11, wherein the plurality of valvular conduits are arranged into one or more paths through each respective stackable plate.

13. The fuel cell ejector of claim 12, wherein each of the plurality of valvular conduits comprises a minor return loop and a major return loop.

14. The fuel cell ejector of claim 13, wherein each of the one or more stackable plates comprises a same number of paths, a same number of minor return loops, and a same number of major return loops.

15. A method comprising:
providing a fuel cell ejector for a hydrogen recirculation system, the fuel cell ejector comprising a valvular conduit manifold;
coupling a primary flow nozzle of the fuel cell ejector to a hydrogen storage tank;
coupling a secondary inlet of the fuel cell ejector to an outlet of a proton exchange membrane fuel cell (PEMFC);
coupling a suction chamber to the primary flow nozzle and the secondary inlet; and
positioning the valvular conduit manifold between the secondary inlet and the outlet of the PEMFC, the valvular conduit manifold comprising at least one minor return loop and at least one major return loop shaped such that hydrogen flows preferentially across the secondary inlet in a first direction from the PEMFC to the suction chamber.

16. The method of claim 15, wherein the at least one minor return loop and the at least one major return loop are diverting loops that create turbulence and eddies that impede a reverse flow of hydrogen in a second direction from the suction chamber to the PEMFC.

17. The method of claim 15, wherein the fuel cell ejector further comprises:
a diffusion chamber; and
a mixing chamber between the diffusion chamber and the suction chamber;
wherein the suction chamber is positioned between the primary flow nozzle and the mixing chamber.

18. The method of claim 15, wherein the valvular conduit manifold comprises one or more stackable plates, each of the one or more stackable plates comprising a plurality of valvular conduits.

19. The method of claim 18, wherein the plurality of valvular conduits are arranged into one or more paths through each respective stackable plate.

20. The method of claim 19, wherein each of the plurality of valvular conduits comprises a minor return loop and a major return loop, and wherein each of the one or more stackable plates comprises a same number of paths, a same number of minor return loops, and a same number of major return loops.
